(19) United States
(12) Patent Application Publication
(10) Pub. No.: US 2002/0080985 A1
(43) Pub. Date: Jun. 27, 2002

(54) Earphone and microphone for a mobile phone

(76) Inventor: Wang-Lin Ho, Tainan City (TW)

Correspondence Address: Wang-Lin HO, P.O. Box 90, Tainan City, 704, TW

(21) Appl. No.: 09/746,008

(22) Filed: Dec. 26, 2000

(51) Int. Cl. H04B 1/38; H04R 1/02; H04R 9/06

(52) U.S. Cl. 381/334; 455/90

(57) ABSTRACT

An earphone and a microphone for a mobile phone includes a microphone contained in a housing, a plug fixed on an upper end of the housing and an earphone combined together. The microphone has a housing, a plug fixed to extend out from the housing for inserting in a socket of a mobile phone, and an flexible antenna to transmit signal to the earphone, a power socket fixed on a side of the housing, a microphone fixed inside for receiving a user's voice. The earphone has a separate case, a clip fixed on a rear of the case to hold the case in a pocket, a wire extending from the case to an earphone body, a power socket on a sidewall of the case, a switch and an indicating lamp on a front side of the case. Then a user does not need to hold the mobile phone for talking.

### BACKGROUND OF THE INVENTION

1. Field of the Invention

This invention relates to a earphone and microphone for a mobile phone, particularly to one composing a microphone with a plug to insert in a socket of a mobile phone and an earphone connected with an antenna to receive and transmit the signal of the mobile phone to the earphone for a driver of a car to use without using his/her hand to hold a mobile phone in communication.

2. Description of the Prior Art

Nowadays, mobile phones have become indispensable for our lives, as modern science and living standard have been growing rapidly and sophisticated. So a driver at the steering wheel often wants to use a mobile phone or has to receive a call from someone with a mobile phone, the driver has to handle the steering wheel with one hand and hold a mobile phone with the other hand, with potential danger easily caused by driving and holding the mobile phone to listen at the same time. And in fact, such accidents have been often reported in news media. Therefore, a conventional earphone and microphone for a mobile phone has been made as shown in FIG. 1, mainly having a plug 11 provided in a bottom of a mobile phone 10, a microphone 13 and a earphone 14 connected to the mobile phone with wires 12.

However, this conventional earphone and microphone for a mobile phone involves a long wire 12 to hang on the body of a user and swinging around, often intertwining with other things, not so convenient to use.

### SUMMARY OF THE INVENTION

This invention has been devised to offer an earphone and microphone for a mobile phone without need of holding it in a hand of a user.

The feature of the invention is a plug provided in a front end of a housing of a microphone to insert in a socket provided in the bottom of a mobile phone, an antenna fixed on one side of the housing of the microphone, and a power socket provided in one side of the housing of the microphone, and an earphone having a case and a clip on a rear surface of the case. The case has a power socket on a side, and a switch and a signal lamp provided on an upper surface.

### BRIEF DESCRIPTION OF DRAWINGS

This invention will be better understood by referring to the accompanying drawings, wherein:

FIG. 1 is a perspective view of a conventional earphone and microphone for a mobile phone;

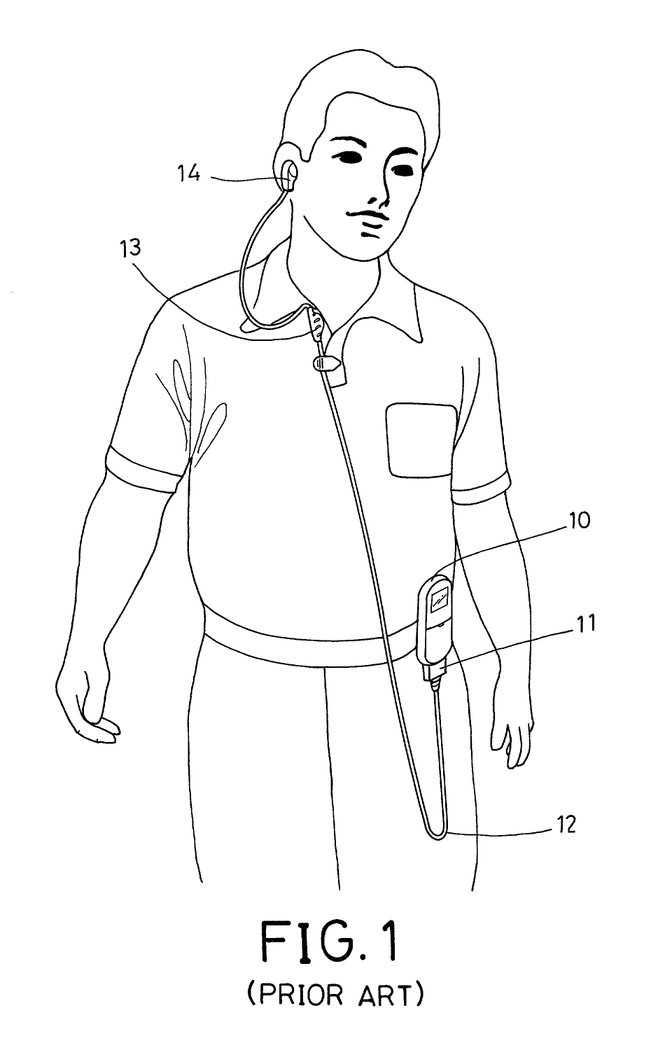

FIG. 2 is an exploded perspective view of a microphone in the present invention;

FIG. 3 is an exploded perspective view of an earphone in the present invention;

FIG. 4 is a side view of the earphone in the present invention; and,

FIG. 5 is a perspective view of the earphone and microphone for a mobile phone in the present invention, showing it practically used by a person.

### DETAILED DESCRIPTION OF THE PREFERRED EMBODIMENT

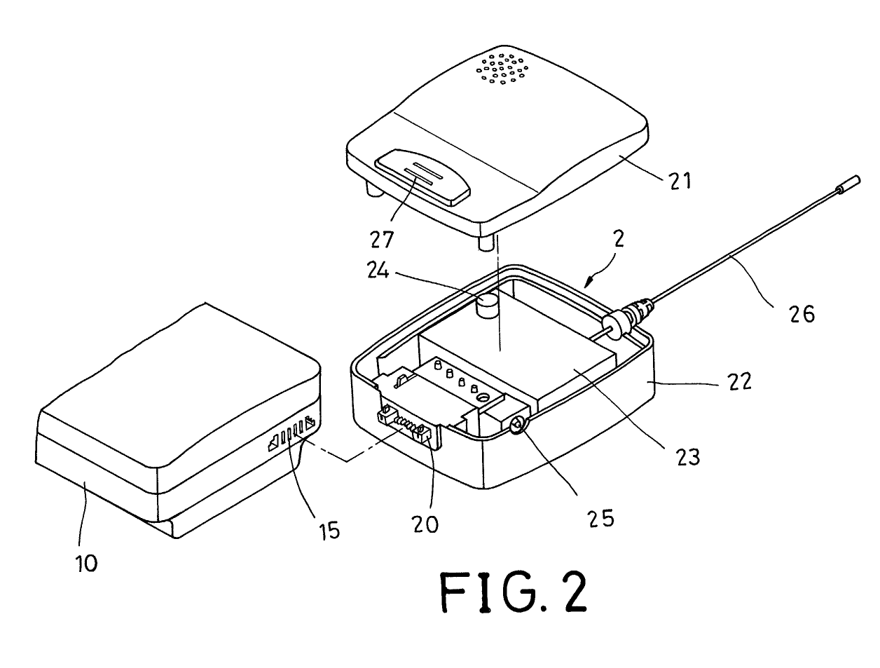

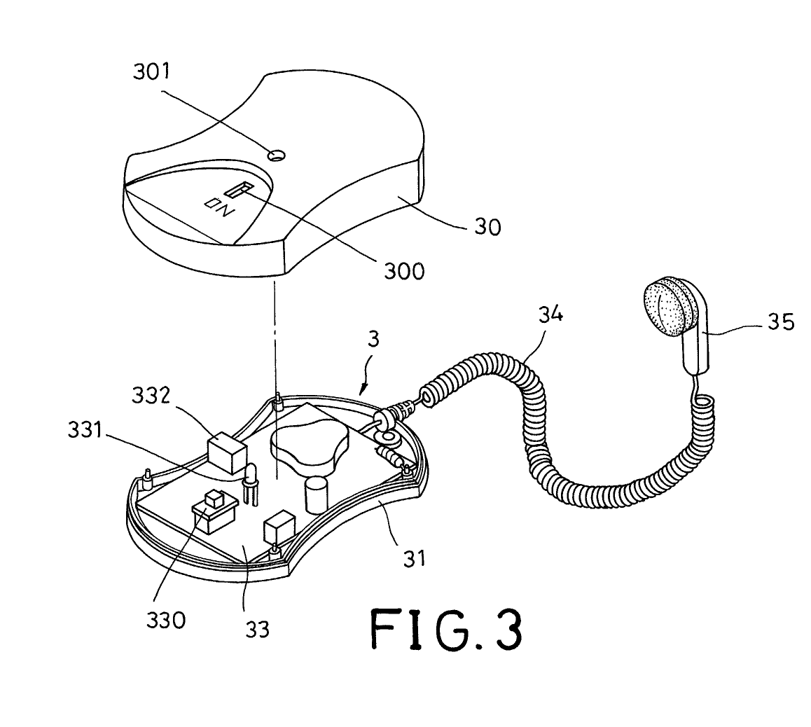

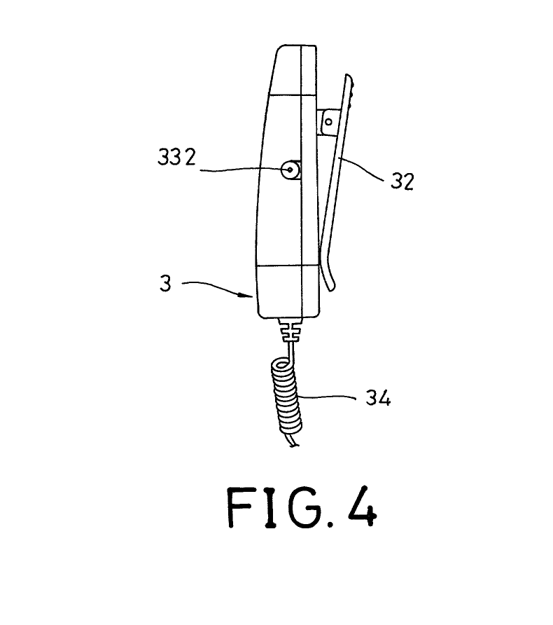

A preferred embodiment of an earphone and microphone for a mobile phone in the present invention, as shown in FIGS. 2, 3 and 4, includes a microphone 2 and an earphone 3 combined together.

The microphone has a microphone housing 2 of a lower housing 21 and 22, a plug 20 formed in the front end of the housing 2 to connect to a socket 15 formed in a bottom of a mobile phone 10 to transmit signals. Further, an antenna 26 is provided on a lower end of the housing 2, made of soft conducting wire material, flexible to bend to any direction or any angle, not to be damaged in case of contacting with the body of a person or something. The housing 2 further has a circuit board 23 in the interior for arrange a microphone 24 and an electronic components thereon, and a power socket 25 fixed on a side wall for connecting with an exterior power source, and a push button 27 fixed on an upper surface of the upper housing 21 for separating the plug 2 from the socket 15 of the mobile phone 10.

The earphone 3 has a separate case consisting of an upper and a lower case 30 and 31, an elastic clip 32 provided on a rear side of the lower case 31, a circuit board 33 contained in the case and having a switch 330, a signal lamp 331 and a power socket 332 arranged thereon. The upper case 30 has a slot 300 and a through hole 301 for respectively the switch 330 and the indicating lamp 331 to pass through up, and a connect wire 34 extending from the circuit board 33 out of the lower case 31 to connect to an earphone body 35.

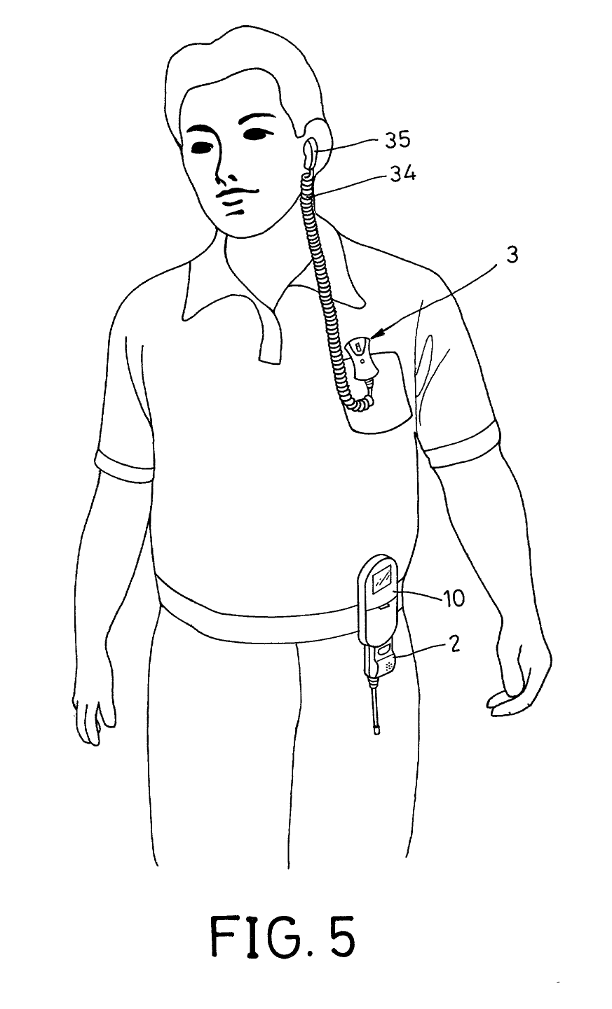

In using, referring to FIGS. 2-5, insert the plug body 20 in the socket 15 of a mobile phone 10, firmly attaching the microphone plug 2 with the bottom of the mobile phone 10, with the antenna 26 properly bent not to collide with any other thing. Then the elastic clip 32 of the earphone 3 is clamped on a pocket or a button and inserts the earphone body 35 in an ear. When the mobile phone receives a signal, turn on the switch 330 of the earphone 3, and then the indicating lamp 331 is lit up, so a user can begin to talk through the microphone to the mobile phone for communication, very convenient without embarrassing and troublesome feeling.

While the preferred embodiment of the invention has been described above, it will be recognized and understood that various modifications may be made therein and the appended claims are intended to cover all such modifications that may fall within the spirit and scope of the invention.

What is claimed is:

1. A earphone and microphone plug for a mobile phone comprising:
a microphone having a housing consisting of an upper housing and a lower housing and a plug body fixed in a front end of said housing for connecting to a socket of a mobile phone, an antenna provided on a lower end of said housing, a microphone provided on a front surface, and a power socket provided on a side wall;
an earphone having a separate case, a flexible clip provided on a rear side of said case, a wire fixed on a lower end of said case and connected between said case and an earphone body, a power socket fixed on a sidewall of said case, a switch and an indicating lamp provided on a front side of said case;
said microphone plug inserted in said mobile phone, communicating signals said mobile phone receives being transmitted by said microphone plug to said earphone, which gives out sound of a partner's voice, a microphone fixed with said microphone plug receiving what a user talks and being transmitted to said mobile phone, which then sends out signals, making up two ways communication.

2. The earphone and microphone plug for a mobile phone as claimed in claim 1, wherein said microphone and said earphone all have a power socket for receiving exterior power.
